(19) United States
(12) Patent Application Publication
(10) Pub. No.: US 2006/0065147 A1
(43) Pub. Date: Mar. 30, 2006

(54) Platemaking method and platemaking apparatus

(75) Inventor: Hideaki Ogawa, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/219,717

(22) Filed: Sep. 7, 2005

(30) Foreign Application Priority Data
Sep. 30, 2004 (JP) 2004-286175
Dec. 10, 2004 (JP) 2004-357586

(51) Int. Cl. B41N 3/00

(52) U.S. Cl. 101/463.1

(57) ABSTRACT

A flexo direct printing plate is engraved in two processes. One is a precision engraving process for irradiating the flexo direct printing plate at a precision engraving pixel pitch with a precision engraving beam having a small diameter, to engrave the plate to a maximum depth. The other is a coarse engraving process for irradiating the flexo direct printing plate at a coarse engraving pixel pitch larger than the precision engraving pixel pitch, with a coarse engraving beam having a large diameter, to engrave the plate to a relief depth.

### BACKGROUND OF THE INVENTION

1. Field of the Invention

This invention relates to a platemaking method and a platemaking apparatus for imaging on image recording materials such as printing plates or printing cylinders (both referred to as printing plates thereafter) for use in relief printing such as flexography, letterpress and in intaglio printing such as photogravure.

2. Description of the Related Art

Conventional platemaking apparatus of the type noted above include a laser engraving machine as described in U.S. Pat. No. 5,327,167, for example. This laser engraving machine makes relief printing plates by scanning an image recording material with a laser beam emitted from a laser source to engrave the surface of the recording material. The machine includes a modulator for modulating the laser beam emitted from the laser source, a recording drum rotatable with the image recording material mounted peripherally thereof, and a recording head movable in a direction parallel to the axis of the recording drum for irradiating the image recording material mounted peripherally of the recording drum with the laser beam emitted from the laser source.

In such a platemaking apparatus for making letterpress printing plates, the main scanning speed of the laser beam, i.e. the rotating speed of the recording drum, is set to a value for obtaining a required maximum engraving depth, based on the power of the laser source and the sensitivity of the image recording material. Areas shallower than the maximum engraving depth are engraved by reducing the power of the laser beam emitted to the image recording material.

A relatively large amount of energy is required for engraving the image recording material with a laser beam. Thus, there is a drawback of consuming a relatively long time in the platemaking process.

### SUMMARY OF THE INVENTION

The object of this invention, therefore, is to provide a platemaking method and a platemaking apparatus that realizes a shortened platemaking time through efficient use of a laser beam.

The above object is fulfilled, according to this invention, by a platemaking method for making a printing plate by scanning and engraving a surface of an image recording material with a laser beam emitted from a laser source and modulated according to an image signal, comprising a first engraving step for irradiating the image recording material at a first pixel pitch with a laser beam having a first beam diameter, thereby to engrave the image recording material to a first depth; and a second engraving step for irradiating the recording material at a second pixel pitch larger than the first pixel pitch with a laser beam having a second beam diameter larger than the first beam diameter, thereby to engrave the image recording material to a second depth greater than the first depth.

With this platemaking method, the platemaking time may be shortened by using the laser beam efficiently.

In the above method, the image recording material is irradiated at a first pixel pitch with a laser beam having a first beam diameter, thereby to engrave the image recording material to a first depth, and thereafter the image recording material is irradiated at a second pixel pitch larger than the first pixel pitch with a laser beam having a second beam diameter larger than the first beam diameter, thereby to engrave the image recording material to a second depth greater than the first depth. Alternatively, after the image recording material is irradiated at the first pixel pitch with the laser beam having the first beam diameter, thereby to engrave the recording material to the first depth, the image recording material may be irradiated at a second pixel pitch smaller than the first pixel pitch with a laser beam having a second beam diameter smaller than the first beam diameter, thereby to engrave the image recording material to a second depth less than the first depth.

As a preferred embodiment, the engraving step using the laser beam having a small diameter may be executed by modulating the laser beam with a modulator, and the engraving step using the laser beam having a large diameter may be executed by setting the laser source to pulse oscillation.

As another preferred embodiment, the engraving step using the laser beam having a small diameter may be executed by setting the laser source to one of continuous oscillation and spuriously continuous oscillation, and the engraving step using the laser beam having a large diameter may be executed by modulating the laser beam with the laser source itself.

As a further preferred embodiment, the engraving step using the laser beam having a large diameter may be executed by preheating the image recording material to a temperature higher than in the engraving step using the laser beam having a small diameter.

In another aspect of the invention, a platemaking apparatus is provided for making a printing plate by scanning and engraving a surface of an image recording material with a laser beam emitted from a laser source. This apparatus comprises a modulator for modulating the laser beam emitted from the laser source; a recording drum for supporting the image recording material as mounted peripherally thereof; a rotary motor for rotating the recording drum; a recording head movable parallel to an axis of the recording drum for irradiating the image recording material mounted peripherally of the recording drum, with the laser beam emitted from the laser source; a moving motor for moving the recording head parallel to the axis of the recording drum; a beam diameter changing mechanism for changing a beam diameter of the laser beam emitted from the recording head; and a controller for controlling the modulator, the rotary motor, the moving motor and the beam diameter changing mechanism, to irradiate the image recording material at a first pixel pitch with a laser beam having a first beam diameter, thereby to engrave the image recording material to a first depth, and thereafter to irradiate the image recording material at a second pixel pitch larger than the first pixel pitch with a laser beam having a second beam diameter larger than the first beam diameter, thereby to engrave the image recording material to a second depth greater than the first depth.

In a further aspect of the invention, a platemaking apparatus is provided for making a printing plate by scanning and engraving a surface of an image recording material with a laser beam emitted from a laser source, the apparatus comprising a modulator for modulating the laser beam emitted from the laser source; a recording drum for supporting the image recording material as mounted peripherally thereof; a rotary motor for rotating the recording drum; a recording head movable parallel to an axis of the recording drum for irradiating the image recording material mounted peripherally of the recording drum, with the laser beam emitted from the laser source; a moving motor for moving the recording head parallel to the axis of the recording drum; a beam diameter changing mechanism for changing a beam diameter of the laser beam emitted from the recording head; and a controller for controlling the modulator, the rotary motor, the moving motor and the beam diameter changing mechanism, to irradiate the image recording material at a first pixel pitch with a laser beam having a first beam diameter, thereby to engrave the image recording material to a first depth, and thereafter to irradiate the image recording material at a second pixel pitch smaller than the first pixel pitch with a laser beam having a second beam diameter smaller than the first beam diameter, thereby to engrave the image recording material to a second depth greater than the first depth.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an outline of a laser engraving machine;

FIG. 2 is a schematic view showing a recording head with a recording drum;

FIG. 3 is a schematic view of an AOM (acoustooptical modulator) unit;

FIG. 4A is an explanatory view schematically showing a shape of a flexo printing plate surface;

FIG. 4B is an explanatory view schematically showing a shape of a flexo printing plate surface;

FIG. 4C is an explanatory view schematically showing a shape of a flexo printing plate surface;

FIG. 5 is an explanatory view of reliefs shapes;

FIG. 6 is a flow chart of a platemaking process;

FIG. 7 is a flow chart of the platemaking process;

FIG. 8 is a graph showing a relationship between engraving sensitivity Y and S/V ratio of recesses processed by a laser beam;

FIG. 9 is an explanatory view schematically showing a method of creating relief data;

FIG. 10 is a schematic view showing an engraving state by a conventional engraving method;

FIG. 11 is a schematic view showing an engraving state by the engraving method according to this invention;

FIG. 12 is a schematic view showing an engraving state by the engraving method according to this invention;

FIG. 13 is an explanatory view schematically showing a shape of an intaglio printing plate;

FIG. 14 is an explanatory view showing a recording beam and others in a precision engraving process;

FIG. 15 is an explanatory view showing a recording beam in a coarse engraving process in a first mode;

FIG. 16 is an explanatory view showing a recording beam and others in a coarse engraving process in a second mode;

FIG. 17 is an explanatory view showing a recording beam in a coarse engraving process in a third mode; and

FIG. 18A is an explanatory view schematically showing a shape of a flexo printing plate surface.

FIG. 18B is an explanatory view schematically showing a shape of a flexo printing plate surface.

FIG. 18C is an explanatory view schematically showing a shape of a flexo printing plate surface.

### DESCRIPTION OF THE PREFERRED EMBODIMENTS

Embodiments of this invention will be described hereafter with reference to the drawings.

The following description will be devoted first to the first characteristic of this invention that shortens a platemaking time by performing an engraving operation in two processes. One of these processes is a precision engraving process for engraving a flexo printing plate 10 to a maximum depth dp by irradiating it at a precision engraving pixel pitch pp with a precision engraving beam L1. The other process is a coarse engraving process for engraving the flexo printing plate 10 to a relief depth d by irradiating it at a coarse engraving pixel pitch pc with a coarse engraving beam L2. Subsequently, the description will deal with the second characteristic of the invention that shortens a platemaking time, while maintaining high platemaking accuracy, by using a laser beam efficiently.

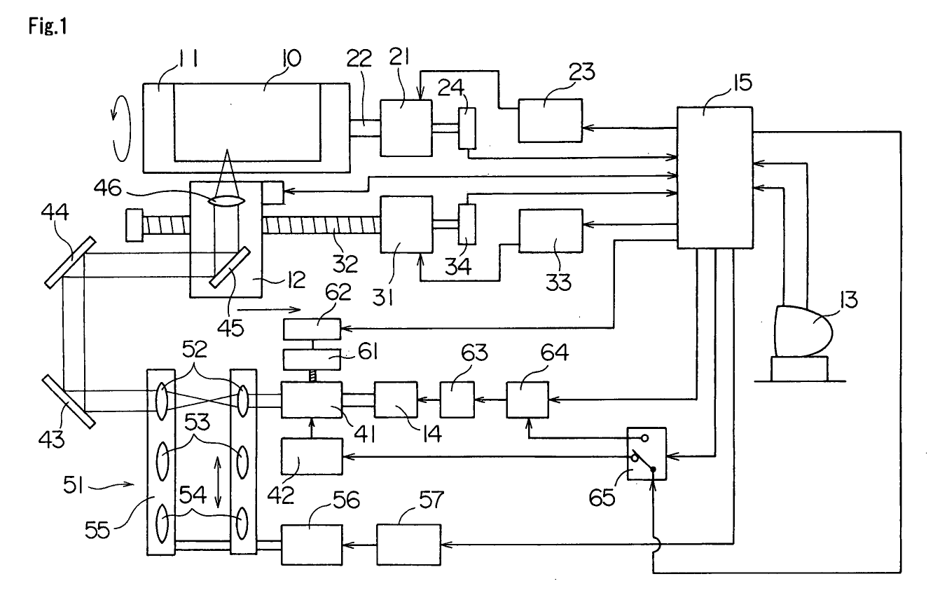

FIG. 1 is a block diagram showing an outline of a laser engraving machine which is a platemaking apparatus for making relief printing plates according to this invention.

The laser engraving machine includes a recording drum 11 for supporting, as mounted peripherally thereof, a flexo direct printing plate (hereinafter called “flexo printing plate”) 10 serving as an image recording material for a letterpress plate, a recording head 12 movable in a direction parallel to the axis of the recording drum 11, a personal computer 13 acting as an input and output device and display unit, a laser source 14 in the form of a gas laser, and a controller 15 for controlling the whole apparatus.

The recording drum 11 is connected to a rotary motor 21 to be rotatable about a shaft 22. The rotary motor 21 is connected to a motor driver circuit 23. The motor driver circuit 23 receives a rotating speed command from the controller 15 to control rotation of the rotary motor 21. A rotating speed of the rotary motor 21 and angular positions of the recording drum 11 rotated by the rotary motor 21 are measured by an encoder 24 which transmits resulting information to the controller 15.

The recording head 12 is guided by a guide device, not shown, to move in the direction parallel to the axis of the recording drum 11. The recording head 12 is driven by a ball screw 32 extending parallel to the axis of the recording drum 11 and rotatable by a moving motor 31, to reciprocate in the direction parallel to the axis of the recording drum 11. The moving motor 31 is connected to a motor driver circuit 33. The motor driver circuit 33 receives a rotating speed command from the controller 15 to control rotation of the moving motor 31. A rotating speed of the moving motor 31 and positions of the recording head 12 moved by the moving motor 31 are measured by an encoder 34 which transmits resulting information to the controller 15.

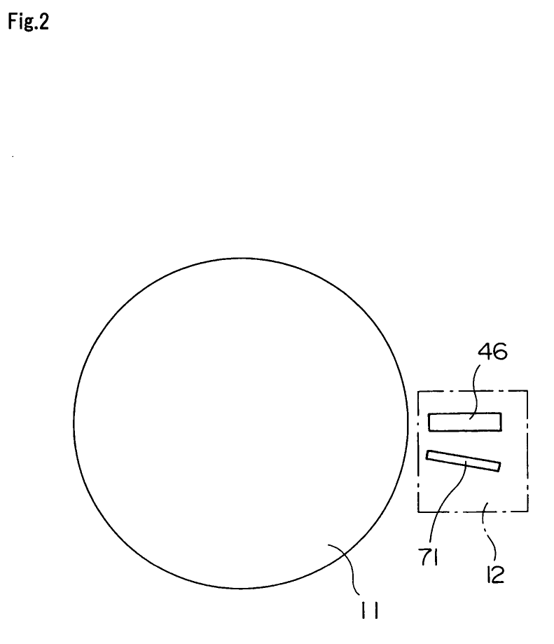

FIG. 2 is a schematic view showing the recording head 12 with the recording drum 11.

The recording head 12 has an objective lens 46 and a preheating mechanism 71 arranged inside. The preheating mechanism 71 is used for preheating the flexo sensitive material 10 mounted peripherally of the recording drum 11. The preheating mechanism 71 may, for example, be a hot air blowing device for blowing hot air toward the flexo printing plate 10 mounted peripherally of the recording drum 11, a halogen lamp for emitting infrared rays to the flexo printing plate 10 mounted peripherally of the recording drum 11, or an induction heating device.

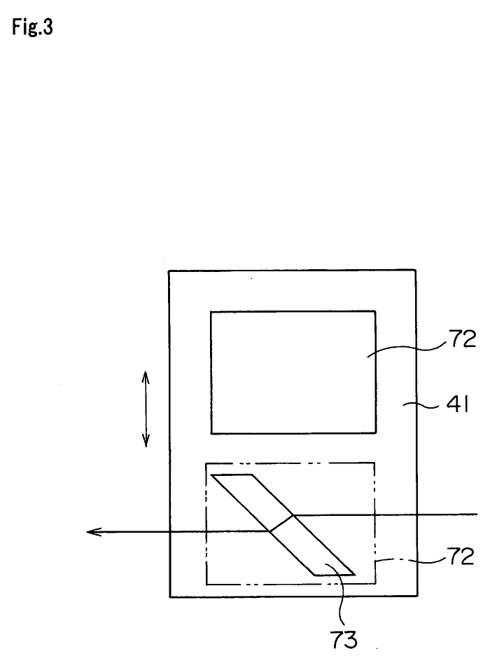

Referring to FIG. 1 again, an AOM unit 41 housing an AOM (acoustooptic modulator) 72 (see FIG. 3) is disposed downstream of the laser source 14. The AOM unit 41 receives image signals from the controller 15 through an AOM driver circuit 42 and a switching circuit 65. The laser beam emitted from the laser source 14 is modulated by the AOM unit 41, and is then directed to the flexo sensitive material 10 mounted peripherally of the recording drum 11, via a variable beam expander 51, a pair of deflecting mirrors 43 and 44 fixed to the apparatus, and a deflecting mirror 45 and objective lens 46 fixed to the recording head 12.

The AOM unit 41 is movable by a motor 61 between a modulating position for modulating the laser beam, and a retreat position. This motor 61 is connected to the controller 15 through a motor driver circuit 62.

FIG. 3 is a schematic view showing the AOM unit 41.

The AOM unit 41 has the AOM 72 and a plane parallel plate 73 arranged inside. When the AOM 72 does not modulate the laser beam, the AOM unit 41 is placed in the retreat position shown in a solid line in FIG. 3. When the AOM unit 41 is required to modulate the laser beam, the motor 61 drives the AOM unit 41 to set the AOM 72 to the modulating position shown in a phantom line in FIG. 3. In the modulating position, the AOM 72 lies on the optical path of the laser beam.

The plane parallel plate 73 lies on the optical path of the laser beam when the AOM unit 41 is placed in the retreat position. The plane parallel plate 73, when the AOM unit 41 is placed in the retreat position, acts to displace the laser beam by an amount corresponding to a displacement of the optical path of the laser beam occurring when the laser beam passes through the AOM 72.

Referring to FIG. 1 again, the variable beam expander 51 changes the diameter of the laser beam emitted from the laser source 14 and irradiating the flexo printing plate 10. The variable beam expander 51 includes three pairs of lenses 52, 53 and 54, a support 55 supporting these lens pairs 52, 53 and 54, and a moving mechanism 56 having a motor for moving the support 55 to set one of the lens pairs 52, 53 and 54 to a position opposed to an exit end of the AOM unit 41. The moving mechanism 56 is connected to a motor driver circuit 57. The motor driver circuit 57 receives a command from the controller 15 to set a lens pair optimal for engraving, among the lens pairs 52 and 53 and 54, to the position opposed to the exit end of the AOM unit 41.

The laser source 14 is connected to the controller 15 through a driver circuit 63 and a laser source control unit 64. The laser source control unit 64 receives a command signal from the controller 15 for continuous oscillation or pulse oscillation to be described hereinafter. The laser source control unit 64 also receives image signals from the controller 15 through a switching circuit 65. The switching circuit 65 receives a switching signal from the controller 15 instructing whether image signals should be transmitted to the laser source control unit 64 or to the AOM driver circuit 42.

In this laser engraving machine, the laser beam emitted from the laser source 14 is modulated by the AOM 72 in the AOM unit 41, and the diameter of the beam is changed by the variable beam expander 51. Then, the beam travels via the deflecting mirrors 43, 44 and 45 and objective lens 46 to be emitted from the recording head 12. With rotation of the recording drum 11 having the flexo printing plate 10 mounted peripherally thereof, the recording head 12 is moved in the direction parallel to the axis of the recording drum 11 to cause the laser beam to scan and engrave the flexo printing plate 10, thereby forming reliefs on the flexo sensitive material 10. However, when the AOM 72 is not used, as described hereinafter, the laser beam is modulated by the laser source 14 itself.

At this time, in this laser engraving machine, the precision engraving process is performed for engraving the flexo printing plate 10 to the maximum depth dp by irradiating it at the precision engraving pixel pitch pp with the precision engraving beam L1 having a small diameter. Then, the coarse engraving process is performed for engraving the flexo printing plate 10 to the relief depth d by irradiating it at the coarse engraving pixel pitch pc larger than the precision engraving pixel pitch pp (equal to a dot pitch) with the coarse engraving beam L2 having a large diameter. The machine shortens the platemaking time by performing the above two processes.

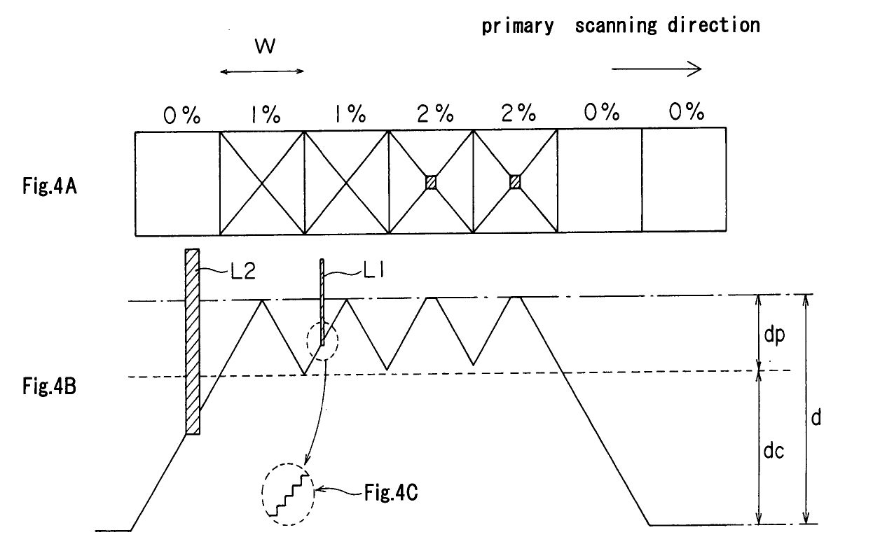

FIG. 4 is an explanatory view schematically showing a shape of the surface of the flexo printing plate 10 engraved by using this laser engraving machine. FIG. 4A is a plan view of seven reliefs formed in a primary scanning direction on the flexo printing plate 10. FIG. 4B is a sectional view of the reliefs. For facility of description, these figures show seven reliefs having dot percentages at 0%, 1%, 1%, 2%, 2%, 0% and 0% in order from left to right.

As seen, the precision engraving beam L1 having a small diameter is used in the precision engraving process. The precision engraving beam L1 irradiates the flexo sensitive material 10 at the precision engraving pixel pitch pp to engrave the flexo printing plate 10 to the maximum depth dp from the surface.

This maximum depth dp corresponds to an engraving depth at boundaries between adjacent reliefs having a very small dot percentage. When the maximum depth dp is smaller than this, minute halftone dots cannot be expressed well. It is possible to make the maximum depth dp larger than this, but then engraving efficiency will become worse. In this embodiment, where reliefs of dot percentage at 1% adjoin each other, the engraving depth at the boundary therebetween is set to the maximum depth dp.

This precision engraving process is carried out to engrave portions of the flexo printing plate 10 that directly influence the shape of halftone dots, from the surface to the maximum depth dp. For this purpose, the relatively small engraving pixel pitch pp is employed at this time, resulting in a minute gradation as schematically shown in FIG. 4C. A small diameter is employed as the diameter of the precision engraving beam L1 at this time for engraving at the precision engraving pixel pitch pp.

The coarse engraving process is performed after the precision engraving process. The coarse engraving beam L2 having a large diameter is used in the coarse engraving process. The coarse engraving beam L2 irradiates the flexo sensitive material 10 at the coarse engraving pixel pitch pc to engrave the flexo printing plate 10 from the maximum depth dp to the relief depth d. Since the areas engraved in the precision engraving process are engraved again in the coarse engraving process, the engraving depth d from the surface of flexo printing plate 10 resulting from the coarse engraving process is greater than the engraving depth dp by the precision engraving. This coarse engraving process is carried out to engrave portions of the flexo sensitive material 10 that have no direct influence on the shape of halftone dots. It is therefore possible to employ the large coarse engraving pixel pitch pc.

At this time, a dot pitch w may be employed as the coarse engraving pixel pitch pc. This coarse engraving pixel pitch pc may be set within a range greater than the precision engraving pixel pitch pp noted above and not exceeding the dot pitch w. The closer the pitch pc is to the dot pitch w, the higher becomes engraving efficiency.

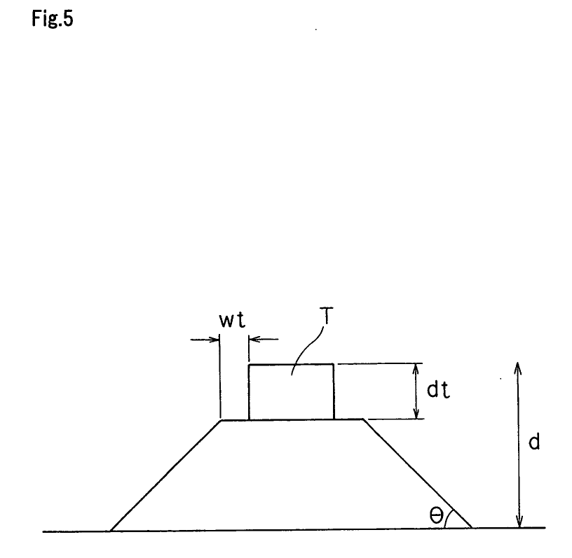

FIG. 5 is an explanatory view showing, more accurately, the shape of a relief formed on the flexo sensitive material 10.

Parameters defining the relief shape include relief angle θ, relief depth d, and step dt and plateau wt for forming top hat T. The relief angle θ has a value common to all reliefs. The relief depth d is an engraving depth for areas of zero dot percent. The step dt is set in order to improve dot gain, and the plateau wt is set in order to increase the mechanical strength of relief. Where the top hat T itself is not formed, the values of step dt and plateau wt become zero. In the foregoing description, step dt and plateau wt are omitted.

Where the relief shape shown in FIG. 4 is employed, the maximum depth dp noted above may be derived from the following equation (1):
dp=(2^{1/2}·pc/2−wt)tan(θπ/180)+dt (1)

Where the top hat T itself is not formed, zero may be substituted for step dt and plateau wt.

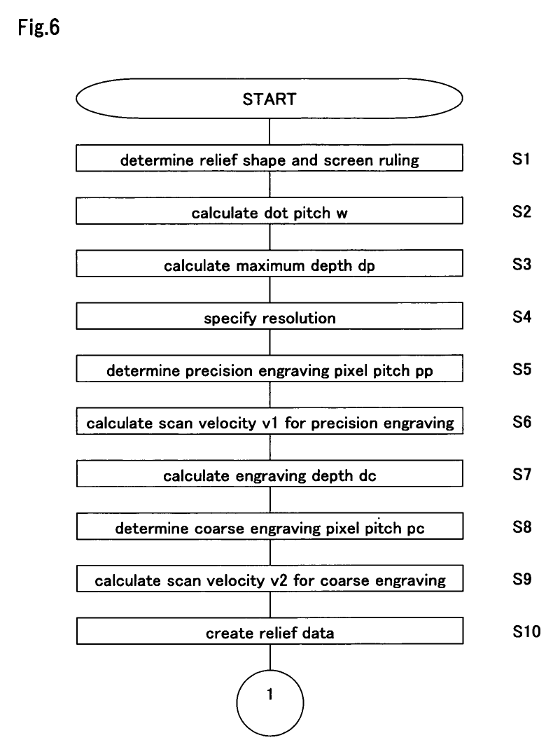

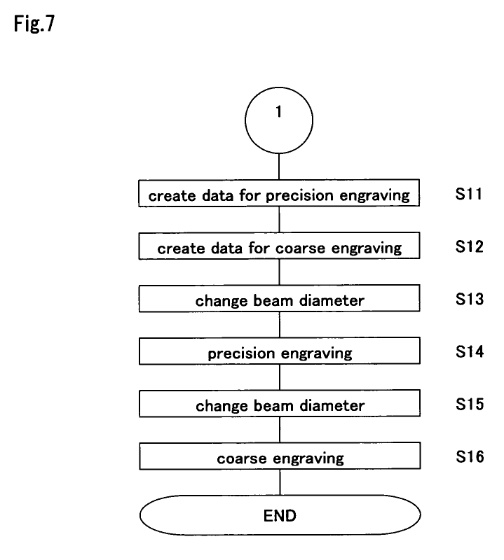

Next, a process of making a flexo printing plate by engraving the flexo printing plate 10 with this laser engraving machine will be described. FIGS. 6 and 7 are flow charts showing the platemaking process.

For making a flexo printing plate, the operator first specifies a relief shape and a screen ruling (step S1). The relief shape and screen ruling are inputted from the personal computer 13 and transmitted to the controller 15.

Next, a dot pitch w is determined from the screen ruling specified (step S2). This dot pitch w is the inverse of the screen ruling.

Next, the maximum depth dp for the precision engraving process is calculated (step S3). This operation is performed using equation (1) noted above.

Next, the operator specifies a resolution (step S4). This resolution is selected from 1200 dpi, 2400 dpi and 4000 dpi, for example.

Next, the precision engraving pixel pitch pp is determined from the resolution specified (step S5). The width in the secondary scanning direction of the precision engraving beam L1 is adjusted to agree substantially with the precision engraving pixel pitch pp.

Next, a scan velocity v1 for the precision engraving is calculated (step S6). This scan velocity v1 is calculated from the following equation (2) based on the precision engraving pixel pitch pp, maximum depth dp, engraving sensitivity Y of the flexo printing plate 10, and power P of the laser beam emitted from the laser source 14 to irradiate the flexo printing plate 10:
pp·dp·v1·Y=P (2)

The engraving sensitivity Y is a value of energy E of the laser beam divided by volume V engraved by the laser beam. The energy E of the laser beam is a value of the power of the laser beam emitted from the laser source 14 to irradiate the flexo printing plate 10 multiplied by an irradiation time.

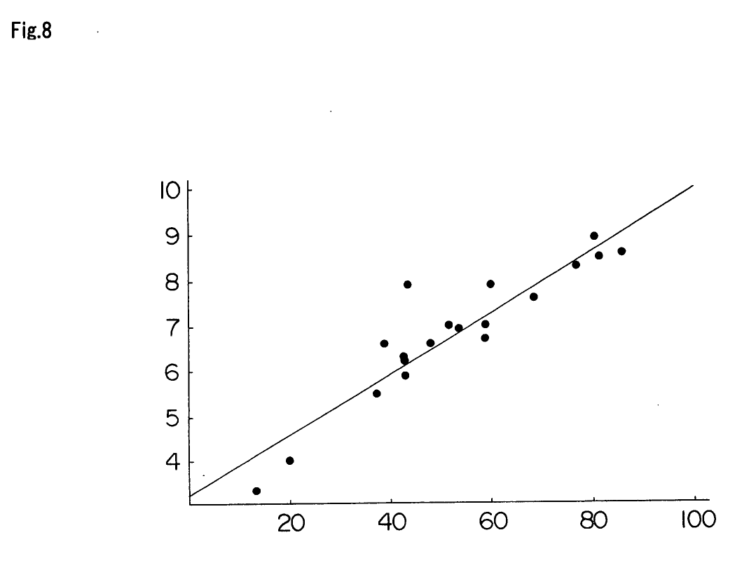

FIG. 8 is a graph showing a relationship between the above engraving sensitivity Y and an S/V ratio of a surface area of a recess engraved by the laser beam, divided by volume.

In this graph, the horizontal axis represents the S/V ratio while the vertical axis represents the engraving sensitivity obtained experimentally. As is clear from the graph, the value of engraving sensitivity increases (i.e. the sensitivity lowers) substantially in proportion to S/V. This is considered due to the fact that the larger the S/V ratio is, the larger the amount of heat dissipation is relative to volume, so that the applied energy is not effectively used for engraving. It is therefore effective to use areas of small S/V ratio in order to perform engraving efficiently.

In the graph shown in FIG. 8, the following approximate expression (3) may be formed:
Y=3.21748+0.0577759X (3)
where Y is engraving sensitivity, and X is the S/V ratio.

Referring to FIGS. 6 and 7 again, the engraving depth dc for the coarse engraving process is calculated next (step S7). This engraving depth dc has a value of the maximum depth dp for the precision engraving subtracted from the relief depth d.

Next, the coarse engraving pixel pitch pc for the coarse engraving is determined (step S8). This coarse engraving pixel pitch pc corresponds to the dot pitch w as noted hereinbefore.

Next, a scan velocity v2 for the coarse engraving is calculated (step S9). As is the scan velocity v1, this scan velocity v2 is calculated from the following equation (4) based on the coarse engraving pixel pitch pc, engraving depth dc, engraving sensitivity Y of the flexo printing plate 10, and power P of the laser beam emitted from the laser source 14 to irradiate the flexo printing plate 10:
pc·dc·v2·Y=P (4)

Next, relief data showing relief shapes to be engraved is created from image data to be formed on the flexo printing plate 10 (step S10). Image data serving as the basis is transmitted on-line or off-line to the controller 15 through the personal computer 13. Relief data is created based on this image data. This relief data is data on which data of each relief is superimposed. Priority is given to data of a relief having smaller depth for mutually overlapping areas.

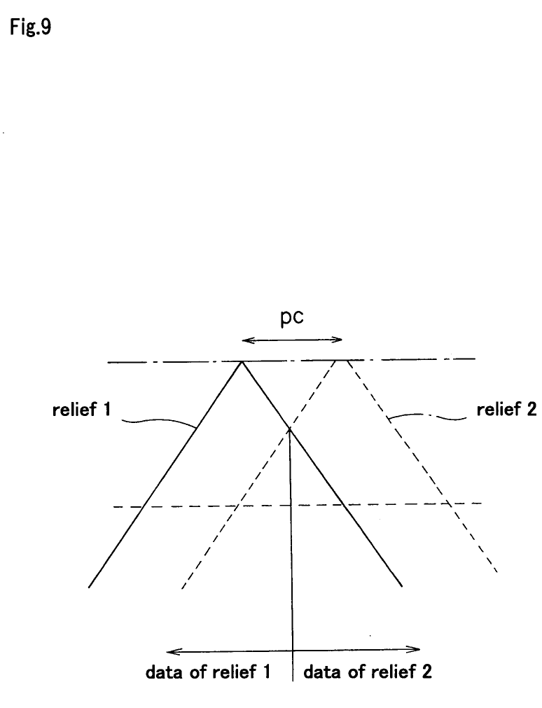

FIG. 9 is an explanatory view schematically showing a method of creating the relief data.

This figure shows a state of relief 1 and relief 2 formed. Data of relief 1 is used for the area on the side of relief 1 from the point of contact between the inclined portions of relief 1 and relief 2, and data of relief 2 is used for the area on the side of relief 2 from the point of contact.

Next, continuous tone data for the precision engraving is created from the relief data (step S11). This continuous tone data is data for engraving areas of zero dot percent to the maximum depth dp. The continuous tone data is created as data for forming inclined portions of reliefs in a stepped form as shown in FIG. 4C, in areas of dot percentage at 0% to 100%.

Next, continuous tone data for the coarse engraving is created from the relief data (step S12). This continuous tone data is data for engraving areas of zero dot percent to the engraving depth dc, taking the relief angle θ into consideration, thereby ultimately to engrave such areas to the relief depth d.

Next, the controller 15 controls the moving mechanism 56 to select one of the lens pairs 52, 53 and 54 that changes the diameter of the laser beam having passed through the variable beam expander 51 into a diameter required for the precision engraving beam L1 (step S13). As a result, the width in the secondary scanning direction of the precision engraving beam L1 is adjusted to agree substantially with the precision engraving pixel pitch pp.

Then, the precision engraving is performed (step S14). At this time, the controller 15 controls the motor driver circuits 23 and 33 to control the rotating speed of the recording drum 11 and the movement speed of the recording head 12 for causing the precision engraving beam L1 to scan the flexo printing plate 10 at the scan velocity v1 described hereinbefore. The controller 15 controls also the AOM driver circuit 42 to engrave the inclined portions and the like to the maximum depth dp.

In time of this precision engraving, as described hereinafter, the AOM unit 41 is set to the modulating position, and the laser source 14 oscillates continuously under control of the laser source control unit 64.

Next, the controller 15 controls the moving mechanism 56 to select one of the lens pairs 52, 53 and 54 that changes the diameter of the laser beam having passed through the variable beam expander 51 into a diameter required for the coarse engraving beam L2 (step S15). As a result, the width in the secondary scanning direction of the coarse engraving beam L2 is adjusted to agree substantially with the coarse engraving pixel pitch pc.

Then, the coarse engraving is performed (step S16). At this time, the controller 15 controls the motor driver circuits 23 and 33 to control the rotating speed of the recording drum 11 and the movement speed of the recording head 12 for causing the coarse engraving beam L2 to scan the flexo printing plate 10 at the scan velocity v2 described hereinbefore. The controller 15 controls also the AOM driver circuit 42 or driver circuit 13 to engrave the inclined portions and the like from the maximum depth dp to the relief depth d. The above process completes the engraving of reliefs as shown in FIG. 4.

In time of this coarse engraving, as described hereinafter, one of the following modes is selected.

(1) Cause the pulse oscillation of the laser source 14, and set the AOM unit 41 to the retreat position;

(2) Cause the pulse oscillation of the laser source 14, and set the AOM unit 41 to the modulating position; and

(3) Cause the continuous oscillation of the laser source 14, and set the AOM unit 41 to the retreat position.

In time of the coarse engraving, the flexo sensitive material 10 is preheated by the preheating mechanism 71.

Next, the conventional platemaking method and the platemaking method according to this invention are compared in respect of engraving time. However, the following comparison is made with the conditions that the laser source 14 is oscillated continuously, no preheating is carried out, and modulation is effected with the AOM 72.

[Conventional Engraving Method]

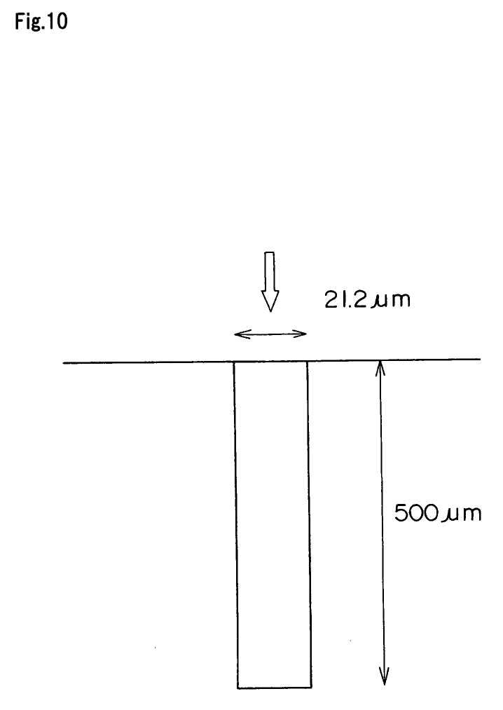

As shown in FIG. 10, for example, a recess 21.2 μm wide and 500 μm deep was engraved with a laser beam having the same diameter as the precision engraving beam L1 at a scan velocity L (mm/s). S and V in this case are expressed by the following equations, and the S/V ratio is about 98:
S=(0.5×2+0.0212×2)·L=1.0424L
V=0.5·0.0212·L=0.0106·L

When the S/V ratio of 98 is substituted for X in equation (3) noted above, the engraving sensitivity Y becomes 9.86 (J/mm³). The energy required to engrave all areas is A·d·Y=9.86·A·d, where A is an engraving area and d is a maximum engraving depth (relief depth). The engraving time te is expressed by the following equation:
te=9.86·A·d/P
where P is the power of the laser beam emitted from the laser source 14 to irradiate the flexo printing plate 10.

Where the engraving area A is 1,000,000 (mm²), the relief depth d is 0.5 (mm) and the power P of the laser beam emitted from the laser source 14 to irradiate the flexo sensitive material 10 is 200 (W), the engraving time te is about 6.8 hours.

### ENGRAVING METHOD ACCORDING TO THIS INVENTION]

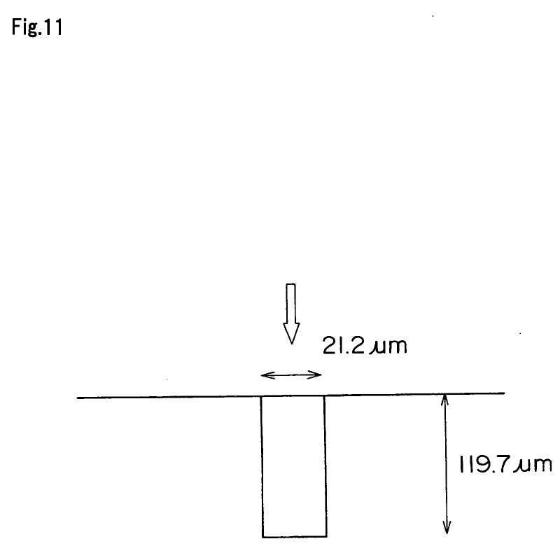

First, the precision engraving was carried out to engrave, as shown in FIG. 11, a recess 21.2 μm wide and 119.7 μm deep with the precision engraving beam L1 at the scan velocity L (mm/s). S and V in this case are expressed by the equations set out hereunder, and the S/V ratio is about 111. The engraving depth of 119.7 μm is derived from equation (1) noted hereinbefore.
S=(0.1197×2+0.0212×2)·L=0.2818L
V=0.1197·0.0212·L=0.00253764·L

When the S/V ratio of 111 is substituted for X in equation (3) noted above, the engraving sensitivity Y becomes 10.7 (J/mm³). The energy required to engrave all areas is A·dp·Y=10.7·A·dp, where A is an engraving area and dp is the maximum depth. The engraving time t1 is expressed by the following equation:
t1=10.7·A˜dp/P
where P is the power of the laser beam emitted from the laser source 14 to irradiate the flexo printing plate 10.

Where the engraving area A is 1,000,000 (mm²), the maximum depth dp is 0.1197 (mm) and the power P of the laser source 14 is 200 (W), the engraving time t1 is about 1.7789 hours.

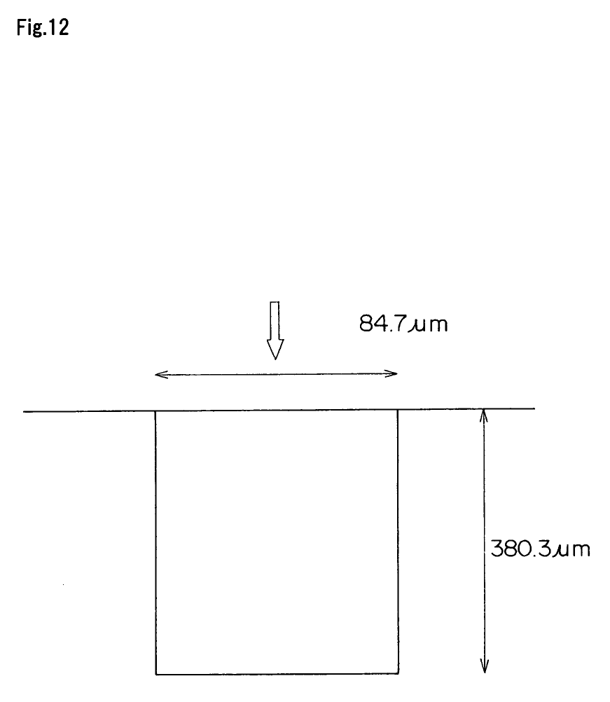

Next, the coarse engraving was carried out to engrave, as shown in FIG. 12, a recess 84.7 μm wide and 308.3 μm deep with the coarse engraving beam L2 at the scan velocity L (mm/s). S and V in this case are expressed by the equations set out hereunder, and the S/V ratio is about 28.9. The engraving depth of 308.3 μm is obtained by subtracting the maximum depth dp from the relief depth d. The engraving width of 84.7 μm is determined based on the coarse engraving pixel pitch pc.
S=(0.3803×2+0.0847×2)·L=0.93L
V=0.3803·0.0847·L=0.032211·L

When the S/V ratio of 28.9 is substituted for X in equation (3) noted above, the engraving sensitivity Y becomes 5.18 (J/mm³). The energy required to engrave all areas is A·dc·Y=5.18·A·dc, where A is an engraving area and dc is the engraving depth. The engraving time t2 is expressed by the following equation:
t2=5.18·A·dc/P
where P is the power of the laser beam emitted from the laser source 14 to irradiate the flexo printing plate 10.

Where the engraving area A is 1,000,000 (mm²), the maximum depth dp is 0.3803 (mm) and the power P of the laser beam emitted from the laser source 14 to irradiate the flexo printing plate 10 is 200 (W), the engraving time t2 is about 2.7361 hours.

The engraving time t which is a sum of the above precision engraving time t1 and coarse engraving time t2 is 4.515 hours. This engraving time t is much shorter than the conventional engraving time te (6.8 hours).

The embodiment described above uses as the recording material a flexo printing plate which is one of the printing plates. This invention is applicable also where recesses are formed by laser engraving in an intaglio printing plate such as a gravure printing cylinder.

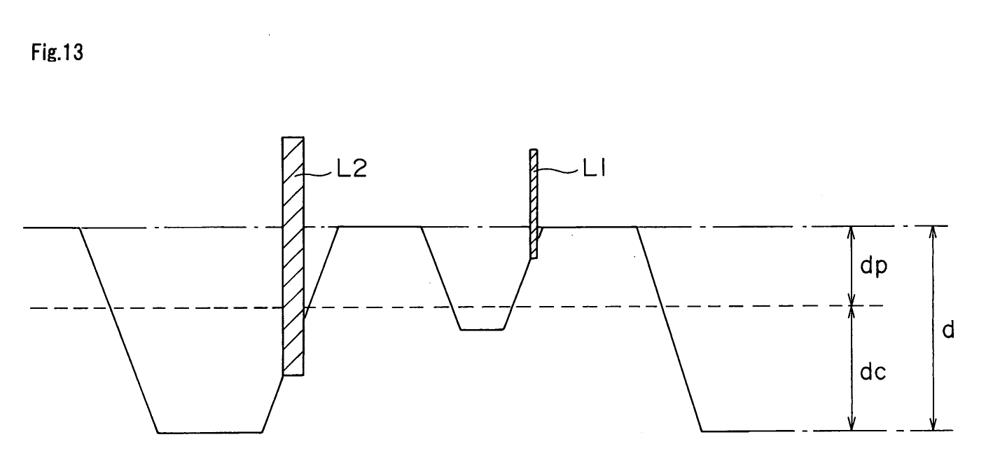

FIG. 13 is an explanatory view schematically showing a shape of an intaglio printing plate in such an embodiment. As seen, when making an intaglio printing plate also, the precision engraving process uses the precision engraving beam L1 having a small diameter. The precision engraving beam L1 is emitted to irradiate the intaglio printing plate at the precision engraving pixel pitch pp to engrave the intaglio printing plate to the depth dp from its surface.

The coarse engraving process is carried out by using the coarse engraving beam L2 having a large diameter. The coarse engraving beam L2 is emitted to irradiate the intaglio printing plate at the coarse engraving pixel pitch pc to engrave the intaglio printing plate from the above-noted depth dp to the depth d. Since the areas engraved in the precision engraving process are engraved again in the coarse engraving process, the engraving depth d from the surface of the intaglio printing plate resulting from the coarse engraving process is greater than the engraving depth dp achieved by the precision engraving. The coarse engraving process is carried out to engrave portions having no direct influence on the shape of cells, which allows the coarse engraving pixel pitch pc to be a large pitch.

Next, description will be made of the second characteristic of the invention that shortens a platemaking time, while maintaining high platemaking accuracy, by using a laser beam efficiently.

The waveform of the laser source 14 is considered first.

An ordinary laser source can switch between continuous oscillation and pulse oscillation. The peak power in time of pulse oscillation is higher than the peak power in time of continuous oscillation. In the case of a carbon dioxide laser, for example, the peak power in time of pulse oscillation is several to 10 times the peak power in time of continuous oscillation, In the case of a YAG laser, the peak power in time of pulse oscillation is about 100 times the peak power in time of continuous oscillation. When engraving a printing plate, the higher peak power enables the more efficient engraving by preventing heat dispersion.

On the other hand, the highest frequency in time of pulse oscillation is about 100 kHz. This frequency is sufficient for the coarse engraving process described hereinbefore, but is insufficient for the precision engraving process. Thus, in the coarse engraving process, the laser source 14 is set to pulse oscillation, while in the precision engraving process, the laser source 14 is set to continuous oscillation and engraving is carried out by modulating the laser beam with a different modulator. In this way, the laser beam is used efficiently to shorten the platemaking time while maintaining high platemaking accuracy.

Next, the presence or absence of a modulator is considered.

The AOM 72 is capable of a high-speed modulation at about 1 MHz, for example. Germanium used in the AOM 72 has low transmittance for a laser beam, and about several percent of the laser beam is lost in the AOM 72. Thus, the laser beam may be modulated by the laser source 14 itself in the coarse engraving process, and modulated by the modulator in the precision engraving process. Then, the laser beam is used efficiently to shorten the platemaking time while maintaining high platemaking accuracy.

In time of the precision engraving process, the laser source 14 may be continuously oscillated in a spurious way. Then, the AOM 72 is driven to modulate the laser beam emitted from the laser source 14.

The following modes are conceivable for continuously oscillating the laser source 14 in a spurious way. When, for example, the driver circuit 63 supplies the laser source 14 with a driving signal of high frequency exceeding a response speed, the laser source 14 will make a pulse oscillation but emit an apparently continuous laser beam. Also when the driver circuit 63 supplies the laser source 14 with a high-duty driving signal, the laser source 14 will make a pulse oscillation but emit an apparently continuous laser beam. Thus, while effecting the continuous oscillation of the laser source 14 in a spurious way, image signals are supplied from the switching circuit 65 to the AOM driver circuit 42 to modulate the laser beam for performing a precision engraving of the flexo printing plate 10.

Preheating is considered next.

It is known that, where the flexo printing plate 10 is used, for example, the processing efficiency by the laser beam will be improved about 30% by heating the flexo sensitive material 10 to about 100° C. beforehand. Thus, such preheating will enable an efficient engraving process. However, when preheating is carried out, the flexo sensitive material 10 will undergo thermal expansion to lower the accuracy of dimension. Variations in the heating temperature will result in variations in the relief depth. Thus, preheating may be effected in the coarse engraving process, while in the precision engraving process, preheating is omitted or is effected at a lower temperature than in the coarse engraving process. Then, the platemaking time may be shortened while maintaining high platemaking accuracy.

Description will be made, based on the above preconditions, of the platemaking process performed on the flexo printing plate 10 shown in FIG. 4.

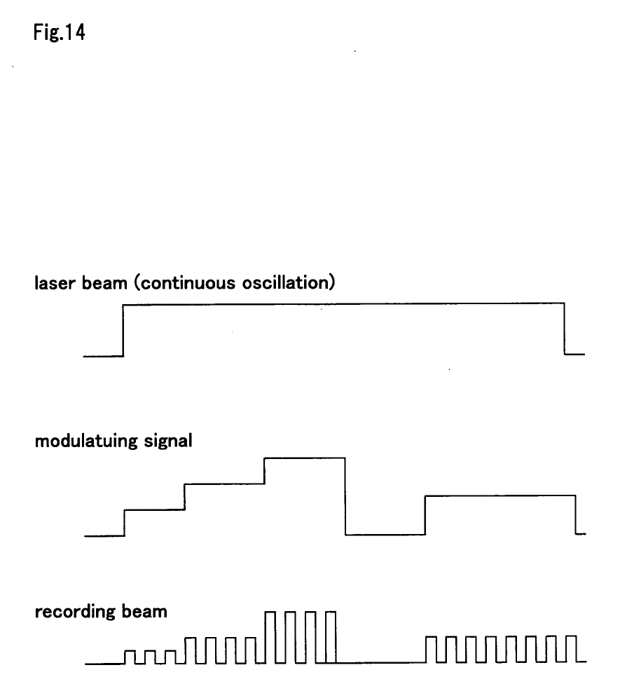

The precision engraving process will be described first. FIG. 14 is an explanatory view showing a recording beam and others in the precision engraving process.

In the precision engraving process, the scan velocity is high because of a relatively small engraving depth and the pixel pitch is minute as noted hereinbefore. Thus, a high modulation frequency is required. In the precision engraving process, therefore, the AOM unit 41 is set to the modulating position. The laser source 14 makes a continuous oscillation or spuriously continuous oscillation under control of the laser source control unit 64. Further, the switching circuit 65 is operated to input the image signals to the AOM driver circuit 42. In this case, as shown in FIG. 14, the laser beam generating from the continuous oscillation may be modulated by the AOM 72 whose modulating efficiency is varied by a modulating signal, to form a recording beam. In the precision engraving process, preheating is omitted in order to secure high engraving accuracy.

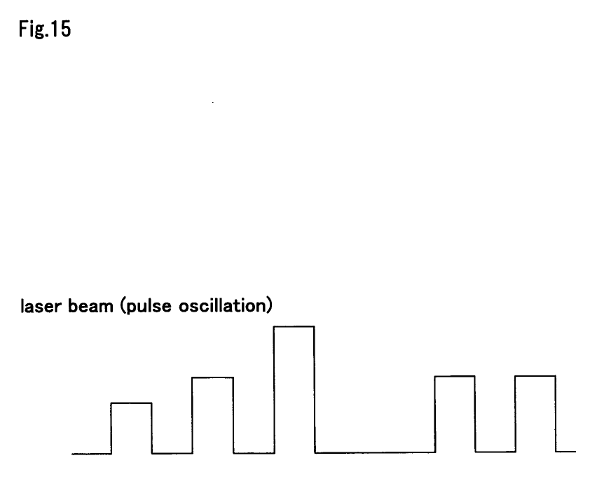

Next, a first mode of performing the coarse engraving process will be described. FIG. 15 is an explanatory view showing a recording beam used in the coarse engraving process in the first mode.

In the coarse engraving process, the scan velocity is slow because of the large engraving depth, and the modulation rate may be relatively low because of the broad pixel pitch. In the coarse engraving process according to the first mode, therefore, the AOM unit 41 is moved to the retreat position. The laser source 14 makes a pulse oscillation under control of the laser source control unit 64. The switching circuit 65 is operated to input the image signals to the laser source control unit 64. Further, the preheating mechanism 71 is operated to preheat the flexo sensitive material 10. In this case, as shown in FIG. 15, the laser beam is modulated by the laser source 14 itself. In this way, the laser source 14 in pulse oscillation emits a laser beam of high peak power. Since the laser beam is modulated by the laser source 14 itself, the quantity of the laser beam is not lost in the AOM 72. Engraving is performed efficiently since the flexo printing plate 10 is preheated. It is thus possible to shorten the platemaking time.

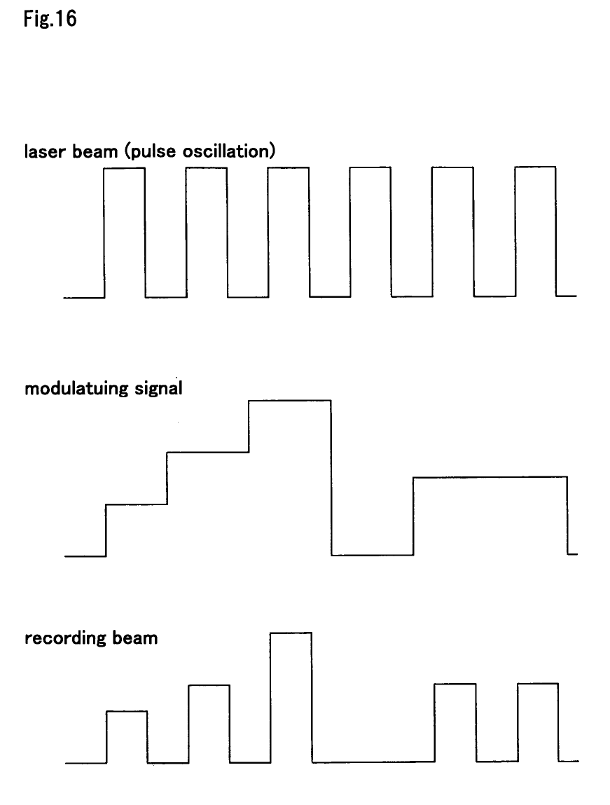

Next, a second mode of performing the coarse engraving process will be described. FIG. 16 is an explanatory view showing a recording beam used in the coarse engraving process in the second mode.

In the coarse engraving process according to the second mode, the AOM unit 41 is moved to the modulating position. The laser source 14 makes a pulse oscillation with constant intensity under control of the laser source control unit 64. The switching circuit 65 is operated to input the image signals to the AOM driver circuit 42. Further, the preheating mechanism 71 is operated to preheat the flexo sensitive material 10. In this case, as shown in FIG. 16, a recording beam may be formed by modulating the laser beam emitted by pulse oscillation at a constant output, based on a modulating signal changing the modulating efficiency of the AOM 72. In this case, the laser source 14 in pulse oscillation emits a laser beam of high peak power. Further, engraving is performed efficiently since the flexo sensitive material 10 is preheated. It is thus possible to shorten the platemaking time. Since the laser beam is modulated using the modulating signal to the AOM 72, accurate modulation is attained.

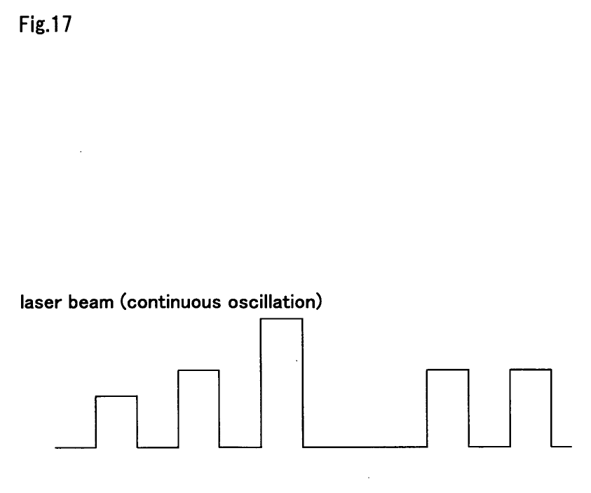

Next, a third mode of performing the coarse engraving process will be described. FIG. 17 is an explanatory view showing a recording beam used in the coarse engraving process in the third mode.

In the coarse engraving process according to the third mode, the AOM unit 41 is moved to the retreat position. The laser source 14 makes a continuous oscillation under control of the laser source control unit 64. The switching circuit 65 is operated to input the image signals to the laser source control unit 64. Further, the preheating mechanism 71 is operated to preheat the flexo printing plate 10. In this case, as shown in FIG. 17, the laser beam is modulated by the laser source 14 itself. Although the laser source 14 emits a laser beam of low peak power, the quantity of the laser beam is not lost in the AOM 72 since the laser beam is modulated by the laser source 14 itself. Engraving is performed efficiently since the flexo printing plate 10 is preheated. It is thus possible to shorten the platemaking time.

In the embodiment described above, the precision engraving process is performed without preheating, in order to secure high engraving accuracy. However, the precision engraving process may include a preheating step carried out at a lower temperature than in the coarse engraving process, to perform engraving efficiently while maintaining required accuracy.

However, preheating is not necessarily indispensable for the coarse engraving process also.

In the embodiment described above, the AOM 72 is moved to the retreat position to be clear of the optical path of the laser beam emitted from the laser source 14. However, instead of moving the AOM 72 itself, an appropriate shunt optical path may be provided for the laser beam emitted from the laser source 14 to reach a selected one of the lens pairs 52, 53 and 54 of the variable beam expander 51 without passing through the AOM 72.

The above embodiment has been described by taking, for example, the processes of engraving an image recording material in sheet formed wrapped around the recording drum 11. Instead, while rotating a cylindrical recording material such as a photogravure cylinder, for example, the surface of this recording material may be engraved directly according to image signals.

In the embodiment described above, the laser beam used in the precision engraving process has a small diameter as the first beam diameter for engraving at the precision engraving pixel pitch pp as the first pixel pitch, to the maximum depth dp as the first depth. The laser beam used in the coarse engraving process has a large diameter as the second beam diameter for engraving at the coarse engraving pixel pitch pc as the second pixel pitch, to the relief depth d as the second depth.

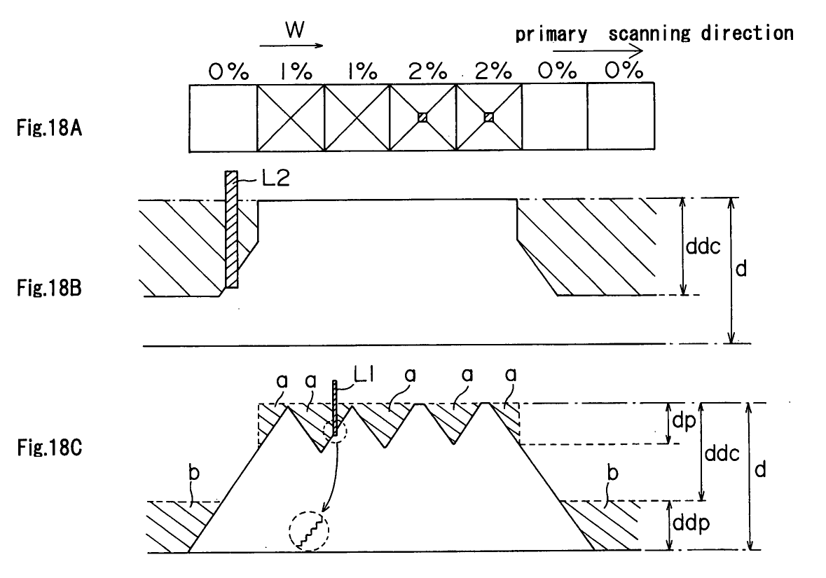

In the embodiment described above, coarse engraving is performed after precision engraving. However, the order of engraving is not limited to this. Coarse engraving may be performed first, and precision engraving performed next. In this case also, the scanning time may be made shorter than where images are recorded only by precision engraving. This example will be described referring to FIG. 18.

FIG. 18 is an explanatory view schematically showing a shape of the surface of the flexo printing plates 10 similar to what has been described with reference to FIG. 4. FIG. 18A is a plan view of seven reliefs formed in the primary scanning direction on the flexo printing plate 10. FIG. 18B is a sectional view of the flexo printing plate 10 having undergone the coarse engraving. FIG. 18C is a sectional view of the flexo printing plate 10 having undergone the precision engraving after the coarse engraving. For facility of description, FIG. 18 shows seven reliefs having dot percentages at 0%, 1%, 1%, 2%, 2%, 0% and 0% in order from left to right.

As shown in FIG. 18B, the coarse engraving process is carried out to engrave areas other than the areas to be engraved only by the precision engraving (i.e. the areas having direct influence on dot shape). That is, the areas shown in hatching are removed by irradiating the flexo sensitive material 10 with the coarse engraving beam L2 at the coarse engraving pixel pitch pc (equal to the dot pitch). This forms inclined portions and the like having no direct influence on the dot shape of each relief.

A maximum engraving depth ddc attained at this stage substantially corresponds to the engraving depth dc described hereinbefore with reference to FIG. 4.

Since this coarse engraving process is carried out to engrave portions having no direct influence on the dot shape, the coarse engraving pixel pitch pc may be a large pitch.

In time of this coarse engraving, as described hereinbefore, one of the following modes is selected.

(1) Cause the pulse oscillation of the laser source 14, and set the AOM unit 41 to the retreat position;

(2) Cause the pulse oscillation of the laser source 14, and set the AOM unit 41 to the modulating position; and

(3) Cause the continuous oscillation of the laser source 14, and set the AOM unit 41 to the retreat position.

In time of the coarse engraving, the flexo sensitive material 10 is preheated by the preheating mechanism 71.

After the coarse engraving process is completed, the precision engraving process is carried out by irradiating the flexo printing plate 10 with the precision engraving beam L1 at the precision engraving pixel pitch pp smaller than the coarse engraving pixel pitch pc. At this stage, as shown in FIG. 18(c), the flexo printing plate 10 is engraved in areas having direct influence on dot shape (i.e. hatched areas a), and in areas having no influence on dot shape but left short of the desired relief depth d by the preceding coarse engraving (i.e. hatched areas b). Since the areas engraved in the coarse engraving process are engraved again in the precision engraving process, the engraving depth d from the surface of the intaglio printing plate resulting from the precision engraving process is greater than the engraving depth ddc achieved by the coarse engraving. The engraving depth ddp of the areas b in the precision engraving process substantially corresponds to the maximum engraving depth dp. The laser source 14 is set to the continuous oscillation or spuriously continuous oscillation as described hereinbefore.

Also when performing the precision engraving after the coarse engraving, a proper relief shape may be formed. In this case, the laser beam used in the coarse engraving process has a large diameter as the first beam diameter for engraving at the coarse engraving pixel pitch pc as the first pixel pitch, to the relief depth d as the first depth. The laser beam used in the precision engraving process has a small diameter as the second beam diameter for engraving at the precision engraving pixel pitch pp as the second pixel pitch, to the maximum depth dp as the second depth.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2004-286175 filed in the Japanese Patent Office on Sep. 30, 2004 and No. 2004-357586 filed in the Japanese Patent Office on Dec. 10, 2004, the entire disclosure of which is incorporated herein by reference.

What is claimed is:

1. A platemaking method for making a printing plate by scanning and engraving a surface of an image recording material with a laser beam emitted from a laser source and modulated according to an image signal, comprising:
a first engraving step for irradiating the recording material at a first pixel pitch with a laser beam having a first beam diameter, thereby to engrave the image recording material to a first depth; and
a second engraving step for irradiating the image recording material at a second pixel pitch larger than said first pixel pitch with a laser beam having a second beam diameter larger than said first beam diameter, thereby to engrave the image recording material to a second depth greater than said first depth.

2. A platemaking method as defined in claim 1, wherein said printing plate is a relief printing plate.

3. A platemaking method as defined in claim 2, wherein said first depth is an engraving depth at a boundary between adjacent reliefs having a substantially zero dot percent.

4. A platemaking method as defined in claim 1, wherein said printing plate is an intaglio printing plate.

5. A platemaking method as defined in claim 1, wherein said first engraving step is executed with a scan velocity determined from said first pixel pitch, said first depth, sensitivity of the image recording material, and power of said laser source.

6. A platemaking method as defined in claim 1, wherein said second engraving step is executed with a scan velocity determined from said second pixel pitch, said second depth, sensitivity of the image recording material, and power of said laser source.

7. A platemaking method as defined in claim 1, wherein said first engraving step is executed by setting said laser source to one of continuous oscillation and spuriously continuous oscillation, and said second engraving step is executed by setting said laser source to pulse oscillation.

8. A platemaking method as defined in claim 1, wherein said first engraving step is executed by modulating the laser beam with a modulator, and said second engraving step is executed by modulating the laser beam with said laser source itself.

9. A platemaking method as defined in claim 1, wherein said second engraving step is executed by preheating said recording material to a temperature higher than in said first engraving step.

10. A platemaking method for making a printing plate by scanning and engraving a surface of an image recording material with a laser beam emitted from a laser source and modulated according to an image signal, comprising:
a first engraving step for irradiating the recording material at a first pixel pitch with a laser beam having a first beam diameter, thereby to engrave the image recording material to a first depth; and
a second engraving step for irradiating the image recording material at a second pixel pitch smaller than said first pixel pitch with a laser beam having a second beam diameter smaller than said first beam diameter, thereby to engrave the image recording material to a second depth less than said first depth.

11. A platemaking method as defined in claim 10, wherein said printing plate is a relief printing plate.

12. A platemaking method as defined in claim 11, wherein said second depth is an engraving depth at a boundary between adjacent reliefs having a substantially zero dot percent.

13. A platemaking method as defined in claim 10, wherein said printing plate is an intaglio printing plate.

14. A platemaking method as defined in claim 10, wherein said first engraving step is executed with a scan velocity determined from said first pixel pitch, said first depth, sensitivity of the image recording material, and power of said laser source.

15. A platemaking method as defined in claim 10, wherein said second engraving step is executed with a scan velocity determined from said second pixel pitch, said second depth, sensitivity of the image recording material, and power of said laser source.

16. A platemaking method as defined in claim 10, wherein said first engraving step is executed by setting said laser source to pulse oscillation, and said second engraving step is executed by setting said laser source to one of continuous oscillation and spuriously continuous oscillation.

17. A platemaking method as defined in claim 10, wherein said first engraving step is executed by modulating the laser beam with said laser source itself, and said second engraving step is executed by modulating the laser beam with a modulator.

18. A platemaking method as defined in claim 10, wherein said first engraving step is executed by preheating said recording material to a temperature higher than in said second engraving step.

19. A platemaking apparatus for making a printing plate by scanning and engraving a surface of an image recording material with a laser beam emitted from a laser source, comprising:
a modulator for modulating the laser beam emitted from said laser source;
a recording drum for supporting the recording material as mounted peripherally thereof;
a rotary motor for rotating said recording drum;
a recording head movable parallel to an axis of said recording drum for irradiating the image recording material mounted peripherally of said recording drum, with the laser beam emitted from said laser source;
a moving motor for moving said recording head parallel to the axis of said recording drum;
a beam diameter changing mechanism for changing a beam diameter of the laser beam emitted from said recording head; and
a controller for controlling said modulator, said rotary motor, said moving motor and said beam diameter changing mechanism, to irradiate the image recording material at a first pixel pitch with a laser beam having a first beam diameter, thereby to engrave the image recording material to a first depth, and thereafter to irradiate the image recording material at a second pixel pitch larger than said first pixel pitch with a laser beam having a second beam diameter larger than said first beam diameter, thereby to engrave the image recording material to a second depth greater than said first depth.

20. A platemaking apparatus as defined in claim 19, further comprising:
a laser source control unit for controlling said laser source to make pulse oscillation and continuous oscillation;
wherein said controller is arranged, with said laser source making one of the continuous oscillation and spuriously continuous oscillation, to irradiate the recording material at the first pixel pitch with the laser beam having the first beam diameter, thereby to engrave the recording material to the first depth, and thereafter, with said laser source making the pulse oscillation, to irradiate the recording material at the second pixel pitch with the laser beam having the second beam diameter, thereby to engrave the recording material to the second depth.

21. A platemaking apparatus as defined in claim 19, further comprising:
a modulator moving mechanism for moving said modulator between a modulating position for modulating the laser beam, and a retreat position;
wherein said controller is arranged, with said modulator moved to the modulating position, to irradiate the image recording material at the first pixel pitch with the laser beam having the first beam diameter and modulated by said modulator, thereby to engrave the image recording material to the first depth, and thereafter, with said modulator moved to the retreat position, to irradiate the image recording material at the second pixel pitch with the laser beam having the second beam diameter and modulated by said laser source itself, thereby to engrave the image recording material to the second depth.

22. A platemaking apparatus as defined in claim 19, further comprising:
a heating mechanism for heating the recording material mounted peripherally of said recording drum;
wherein said controller is arranged to irradiate the image recording material at the first pixel pitch with the laser beam having the first beam diameter, thereby to engrave the image recording material to the first depth, and thereafter, with the image recording material preheated by said heating mechanism, to irradiate the image recording material at the second pixel pitch with the laser beam having the second beam diameter, thereby to engrave the image recording material to the second depth.

23. A platemaking apparatus for making a printing plate by scanning and engraving a surface of an image recording material with a laser beam emitted from a laser source, comprising:
a modulator for modulating the laser beam emitted from said laser source;
a recording drum for supporting the recording material as mounted peripherally thereof;
a rotary motor for rotating said recording drum;
a recording head movable parallel to an axis of said recording drum for irradiating the image recording material mounted peripherally of said recording drum, with the laser beam emitted from said laser source;
a moving motor for moving said recording head parallel to the axis of said recording drum;
a beam diameter changing mechanism for changing a beam diameter of the laser beam emitted from said recording head; and
a controller for controlling said modulator, said rotary motor, said moving motor and said beam diameter changing mechanism, to irradiate the image recording material at a first pixel pitch with a laser beam having a first beam diameter, thereby to engrave the image recording material to a first depth, and thereafter to irradiate the image recording material at a second pixel pitch smaller than said first pixel pitch with a laser beam having a second beam diameter smaller than said first beam diameter, thereby to engrave the image recording material to a second depth greater than said first depth.

24. A platemaking apparatus as defined in claim 23, further comprising:
a laser source control unit for controlling said laser source to make pulse oscillation and continuous oscillation;
wherein said controller is arranged, with said laser source making the pulse oscillation, to irradiate the image recording material at the first pixel pitch with the laser beam having the first beam diameter, thereby to engrave the recording material to the first depth, and thereafter, with said laser source making one of the continuous oscillation and spuriously continuous oscillation, to irradiate the recording material at the second pixel pitch with the laser beam having the second beam diameter, thereby to engrave the recording material to the second depth.

25. A platemaking apparatus as defined in claim 23, further comprising:
a modulator moving mechanism for moving said modulator between a modulating position for modulating the laser beam, and a retreat position;
wherein said controller is arranged, with said modulator moved to the retreat position, to irradiate the image recording material at the first pixel pitch with the laser beam having the first beam diameter and modulated by said laser source itself, thereby to engrave the image recording material to the first depth, and thereafter, with said modulator moved to the modulating position, to irradiate the image recording material at the second pixel pitch with the laser beam having the second beam diameter and modulated by said modulator, thereby to engrave the image recording material to the second depth.

26. A platemaking apparatus as defined in claim 23, further comprising:
a heating mechanism for heating the recording material mounted peripherally of said recording drum;
wherein said controller is arranged, with the image recording material preheated by said heating mechanism, to irradiate the image recording material at the first pixel pitch with the laser beam having the first beam diameter, thereby to engrave the image recording material to the first depth, and thereafter, with the image recording material at a low temperature without being heated by said heating mechanism, to irradiate the image recording material at the second pixel pitch with the laser beam having the second beam diameter, thereby to engrave the image recording material to the second depth.
